(19) United States
(12) Patent Application Publication
(10) Pub. No.: US 2009/0125905 A1
(43) Pub. Date: May 14, 2009

(54) METHOD, APPARATUS AND COMPUTER PROGRAM FOR MODIFYING A MESSAGE

(75) Inventors: Amanda E. Chessell, Alton (GB); Andrew J. Stanford-Clark, Chale (GB)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/266,737

(22) Filed: Nov. 7, 2008

(30) Foreign Application Priority Data
Nov. 9, 2007 (EP) 07120335.0

(51) Int. Cl. G06F 9/46; G06F 15/16

(52) U.S. Cl. 718/100; 709/206

(57) ABSTRACT

There is disclosed a method, apparatus and computer program for modifying a message. A message is received from a first entity. The message contains a first level of detail appropriate to the first entity and the message is for communication to a second entity. It is determined whether the message contains a scope sensitive field. Once it has been determined that the message does contain a scope sensitive field, information is accessed indicating how to transform the scope sensitive field to a second level of detail appropriate to the second entity. The scope sensitive field is then transformed to produce the second level of detail.

### FIELD OF THE INVENTION

The present invention is related to messaging and more particularly to the modification of a message.

### BACKGROUND OF THE INVENTION

Event processing is a style of application design where one program (called the event source 1) produces a message that describes something that happened. This message is called an event. The event source passes it into an event processing network 5. The event processing network delivers the event to one or more programs (called the event destinations 6, 7, 8) which then act on the contents of the event. This is shown in FIG. 1.

In this style of application, the event source is not aware which programs will be the event destinations. The event processing network is responsible for this determination. For example, an event destination can subscribe to receive particular events, or the event processing network can be configured to invoke a particular event destination when an event of a particular type is passed to the event processing network.

As alluded to in the paragraph above, events are typed messages. They have a schema that describes their structure—for example, what the data fields are and the order that they appear in. The content of the event typically includes:

What happened to cause the event (that is what type of event it is)

When the event occurred

Where this event occurred

Describing time and location is problematic if one does not understand how the information is to be used. For example, consider you are on holiday abroad and someone asks you where you live. Of course, you know where you live, but this can sometimes be hard to answer if you do not understand the level of knowledge of the UK's geography that the questioner has. Do you just say “the UK”—or “Southern England” or the name of your street. Describing time has a similar issue to location—how accurate is appropriate—again it depends on the use that the result is to be put to.

In event processing, “where” and “when” an event occurred is called the event context. Providing appropriate levels of detail in these fields is difficult for the event source (and designer of the event schema) for all but the smallest local event processing network because the relevant level of detail is determined by who the event destination is and when they are processing the event. The usual approach is to provide complete information on time and location. For example, specifying a location of a software fault which includes:

code line number

software program

software process

hardware machine

hardware subsystem

building location

postal address

This way the destination can filter out the information that is not relevant to them.

The problem with this approach is that it is expensive in terms of processing power and network bandwidth to manage the event—especially for event destinations that do not need that level of detail. It also raises issues of privacy and legal disclosure when events are passed between organizations.

Co-pending patent application, attorney docket GB920060069 discloses a method for modifying existing aspects of an endpoint reference (EPR) representing a web service endpoint. The EPR (e.g. the address or policy metadata) is modified in dependence upon at least one attribute of the recipient to which the EPR is to be propagated. A possible attribute is the location of the recipient, based on a service level agreement between the web service endpoint and the recipient. Such a solution is however specific to the modification of an EPR based on an attribute of the receiving client. A more flexible solution is required.

### SUMMARY

According to a first aspect, there is provided a method for modifying a message, the method comprising:

receiving a message from a first entity, the message containing a first level of detail appropriate to the first entity, the message for communication to a second entity;

determining whether the message contains a scope sensitive field;

responsive to determining that the message does contain a scope sensitive field, accessing information indicating how to transform the scope sensitive field to a second level of detail appropriate to the second entity;

and transforming the scope sensitive field to produce the second level of detail.

Preferably a scope sensitive gateway (SSG) defines a transition through a scope boundary—e.g. between a warehouse network and an enterprise wide area network (WAN). This means that the level of detail appropriate to entities on the input side of the SSG may be different to the level of detail appropriate to entities on the output side of the SSG. For example, a more generic level of detail may be appropriate to entities on the output side, whilst a more specific level of detail is appropriate to entities on the input side of the SSG.

It is preferably not necessary for the first entity to be aware of who the second entity is.

Further, there is preferably no requirement for the entities to be aware of their scope (although of course they may be).

According to one embodiment, determining whether the message contains a scope sensitive field comprises:

identifying a message type;

and accessing a message schema for the identified message type, the message schema indicating whether the message contains any scope sensitive fields.

Preferably the message including the transformed scope sensitive field is transmitted to the second entity.

The transformation of the scope sensitive field may comprise deleting, modifying or replacing the scope sensitive field.

In one embodiment, it is determined whether the message includes a tracking number. If it does, then the tracking number is preferably used to transform an associated scope sensitive field. This may involve retrieving scope sensitive field information associated with the tracking number.

In one embodiment, if a scope sensitive field has been identified and it has been determined that the message does not include a tracking number, then a tracking number is assigned to the message and the scope sensitive field's information is associated with the tracking number. The message including the assigned tracking number is then preferably transmitted.

According to a second aspect, there is provided an apparatus for modifying a message, the apparatus comprising:

means for receiving a message from a first entity, the message containing a first level of detail appropriate to the first entity, the message for communication to a second entity;

means for determining whether the message contains a scope sensitive field;

means, responsive to determining that the message does contain a scope sensitive field, for accessing information indicating how to transform the scope sensitive field to a second level of detail appropriate to the second entity;

and means for transforming the scope sensitive field to produce the second level of detail.

According to a third aspect, there is provided a computer program for modifying a message, the computer program comprising computer program means adapted to perform the following steps when executed on a computer:

receiving a message from a first entity, the message containing a first level of detail appropriate to the first entity, the message for communication to a second entity;

determining whether the message contains a scope sensitive field;

responsive to determining that the message does contain a scope sensitive field, accessing information indicating how to transform the scope sensitive field to a second level of detail appropriate to the second entity;

and transforming the scope sensitive field to produce the second level of detail.

### BRIEF DESCRIPTION OF THE DRAWINGS

Preferred embodiments of the present invention will now be described, by way of example only, and with reference to the following drawings:

FIG. 1 illustrates an overview of an event processing environment in accordance with one embodiment of the present invention;

FIG. 2 shows a component diagram operating in accordance with one embodiment of the present invention;

FIG. 3 shows a scope sensitive gateway in accordance with one embodiment of the present invention;

FIG. 4a illustrates an exemplary schema;

FIG. 4b illustrates exemplary transformations;

FIG. 5 is a flow chart of the processing of one embodiment of the present invention;

FIGS. 6a, 6b and 6c provide exemplary configurations of the scope sensitive gateways; and

FIGS. 7, 8a, 8b and 8c illustrate a modified scope sensitive gateway and its processing in accordance with another embodiment of the present invention.

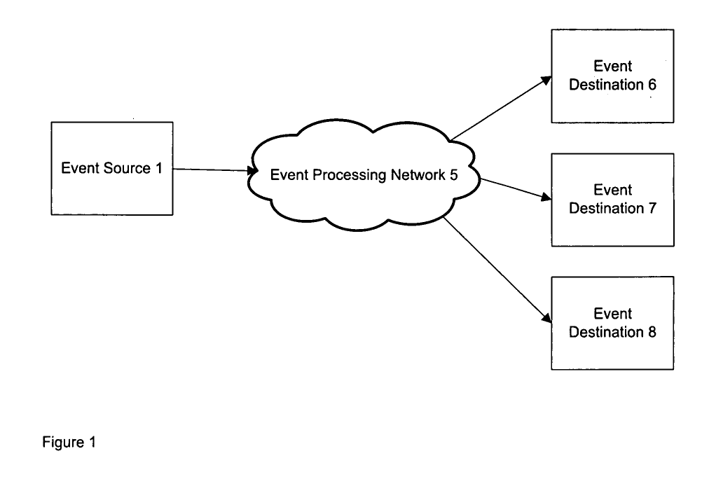

### DETAILED DESCRIPTION

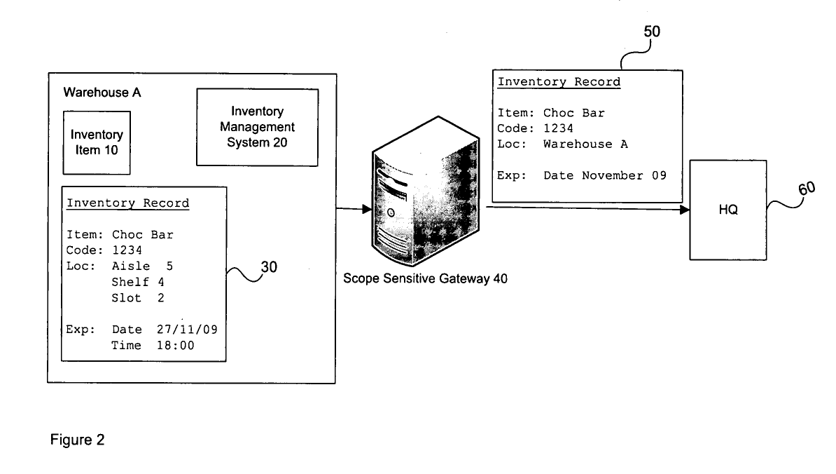

FIG. 2 illustrates an exemplary system operating in accordance with one embodiment of the present invention. A warehouse A stocks inventory items, one of which is shown 10. An inventory management system (IMS) 20 keeps track of such inventory items 10 using inventory records. By way of example, item 10 is a chocolate bar which is described using inventory record 30. Thus it can be seen that chocolate bar 10 has a product code of 1234, and a location (loc) of aisle 5, shelf 4, slot 2. It also has an expiry date and time (exp) of Nov. 27, 2009, 18:00.

A headquarters (HQ) 60 of the company that owns warehouse A may subscribe to receive information about the items managed by IMS 20 (e.g. the addition of any item of stock). (It should be appreciated that the invention is not limited to an environment in which entities subscribe to receive information; an entity may request information on a per need basis).

As discussed in the background section, HQ may not be interested in the exact level of detail held by warehouse A in its inventory records. In accordance with one embodiment, therefore, inventory record 30 is sent via a scope sensitive gateway (SSG) 40.

SSG 40 is responsible for amending inventory record 30 into a form that is appropriate to the entity that has subscribed to receive the inventory record. This will be explained in more detail later.

In the example, HQ 60 is not interested in the precise location of the chocolate bar; it is enough to know that item 10 is located in warehouse A. Similarly, all HQ needs to know is that the chocolate bar expires in November 2009.

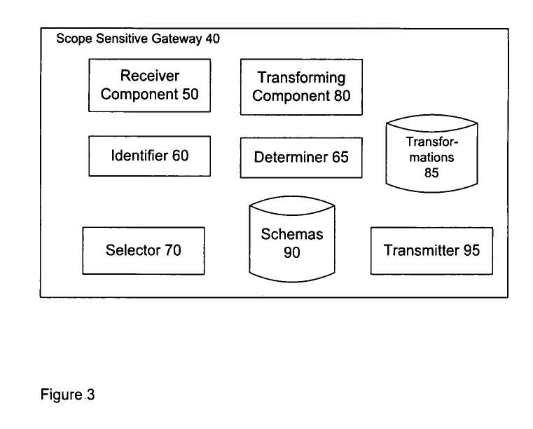

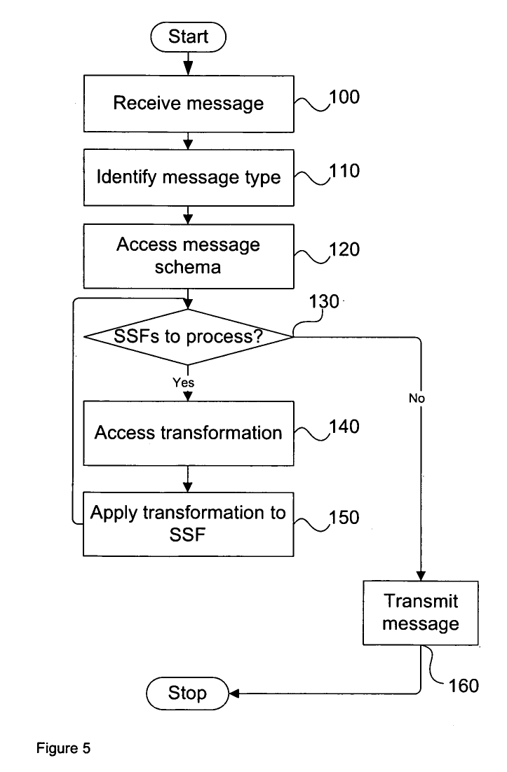

FIG. 3 illustrates, in accordance with one embodiment, the scope sensitive gateway in more detail. FIG. 5 is a flow chart of the operation of the present invention, in accordance with one embodiment. The figures should be read in conjunction with one another.

At step 100, a message (event) is received by the receiver component 50 of the scope sensitive gateway 40. Identifier 60 identifies the message type at step 110. In the example, the message is an inventory record. Thus at step 120, an appropriate schema is accessed from a database of schemas 90 (using selector 70).

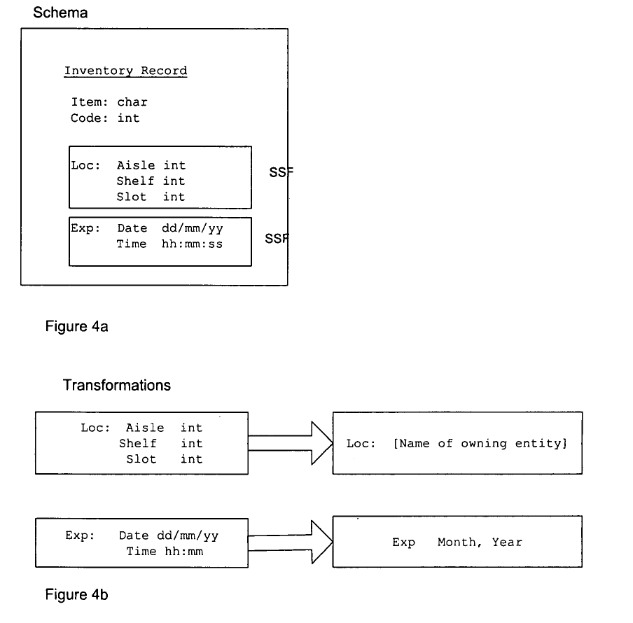

FIG. 4a provides an example of an inventory record schema. From this figure it can be seen that an inventory records has an item field of type char and a code field of type int. Furthermore, the record should include two fields which are denoted as scope sensitive fields (SSF). These are the location (loc) and Expiry (Exp) fields.

There are many ways that event schema can be specified. For example, if the event schema was specified in Unified Markup Language (UML), a scope-sensitive location field could be flagged using a stereotype of <<scope_sensitive_location>>. This indicates that the information within the location field is scope sensitive. The structure of the scope sensitive field could be expressed in associated subclasses.

At step 130, of FIG. 5, determiner 65 determines whether a message of the identified type includes any scope sensitive fields for processing. It can be seen from the message schema of FIG. 4a, that an inventory record includes two SSFs; the location field and the expiry field. Thus at step 140, transforming component 80 accesses the transformations database 85 to locate a transformation appropriate to the message type (inventory record) and the specific SSF within the inventory record (e.g. the location field). Thus transformations may be organised according to message type and then by SSF.

FIG. 4b illustrates exemplary transformations for both the location and expiry SSFs. It can therefore be seen that a location SSF including aisle, shelf and slot information is transformed to include only the name of the owning entity, in this case Warehouse A. The SSG will be aware of the source of an event and also the intended destination for the event and may use this information to substitute in the appropriate information. To explain in more detail, it's the scope/context of the “input” side of the SSG that is used. The source might not actually know it's in warehouse A—it's the fact that the SSG sits on the boundary between the warehouse network and the enterprise WAN and knows through its configuration that anything that comes into it must by definition (or, by scope) be in warehouse A.

Again, FIG. 4b shows that the expiry information is to be transformed to include only month and year information.

Thus transforming component 80 accesses the appropriate transformation at step 140 and applies that transformation to the scope sensitive field of the received message at step 150.

Transforming component 80 then determines whether there is another SSF (step 130) and processing continues to loop round until all SSFs have been transformed. At step 160, transmitter 95 transmits the received message to the subscribing entity 60. Processing then ends. The message 50 that is transmitted to HQ 60 is shown in FIG. 2.

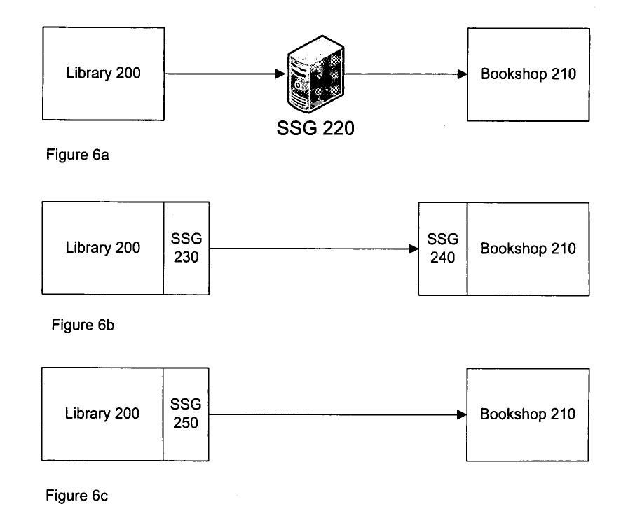

It should be appreciated that various SSG configurations are possible. FIGS. 6a, 6b and 6c illustrate some possibilities. FIG. 6a shows the solution just discussed where an SSG 220 sits between two entities. In the figure, the two entities are a library 200 and a bookshop 210. In this example the SSG receives all messages that pass between the two entities and is responsible for looking for SSFs whenever a new message is received. The gateway is thus configured with the incoming scope information and the outgoing scope information. For each event, it checks the schema to see if there are any scope-sensitive fields present. For each SSF, it selects the appropriate transformation to update the scope-sensitive field to an appropriate set of values for the outgoing scope. This will most likely change the structure of the subfields within the scope-sensitive field.

FIG. 6b shows a solution in which each entity has its own SSG. In this solution both SSGs are either tasked with looking at incoming or outgoing messages; they both must do the same however in order not to duplicate effort.

Finally FIG. 6c shows a solution where an SSF is co-located with just one of the entities.

Sometimes two entities will be involved in request-response type processing. A message's SSF may be modified before it is sent from the first entity to the second entity. However, if the first entity is due a reply, it may also be necessary to modify the SSF back to its original form. This requires a stateful Scope Sensitive Gateway.

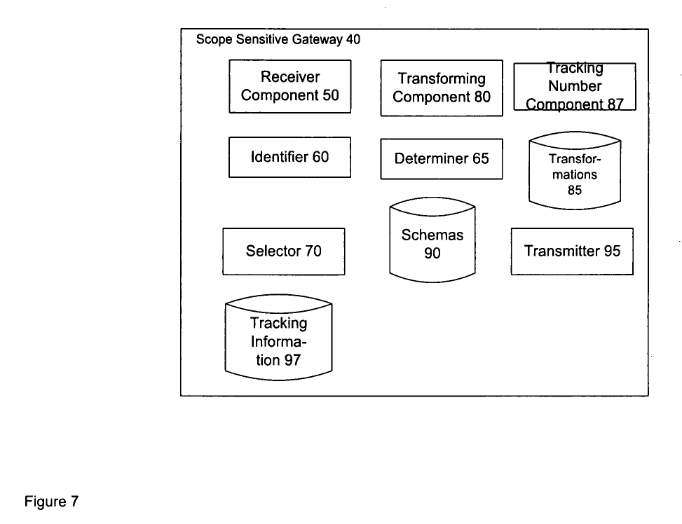

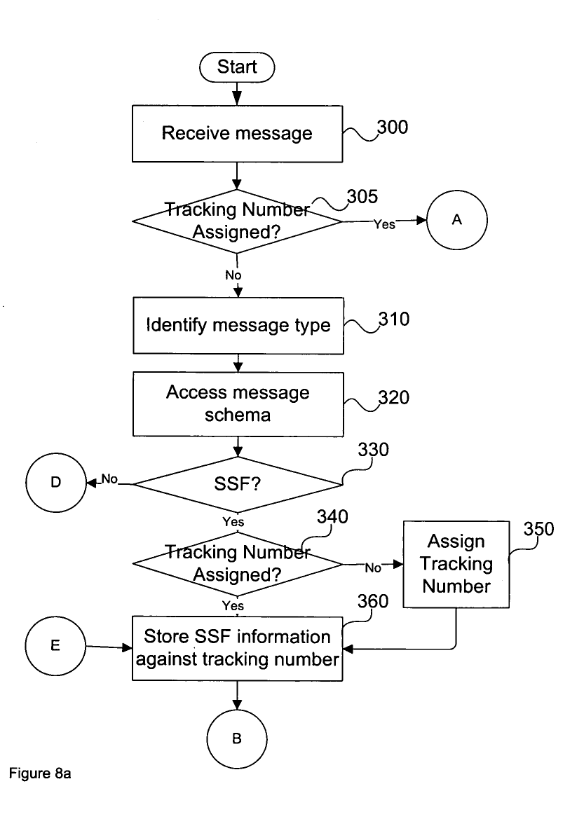

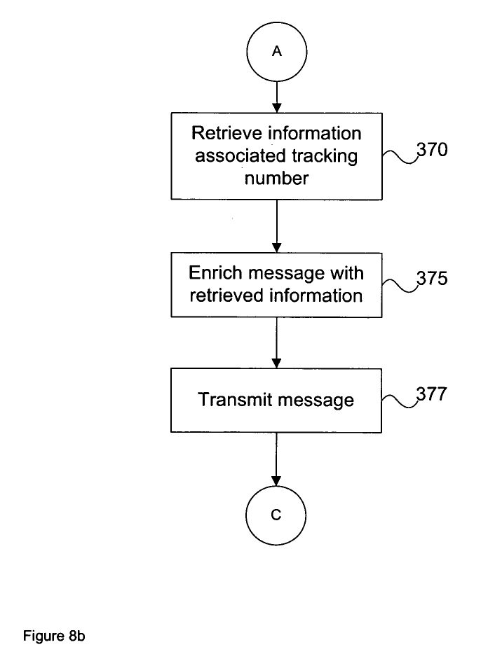

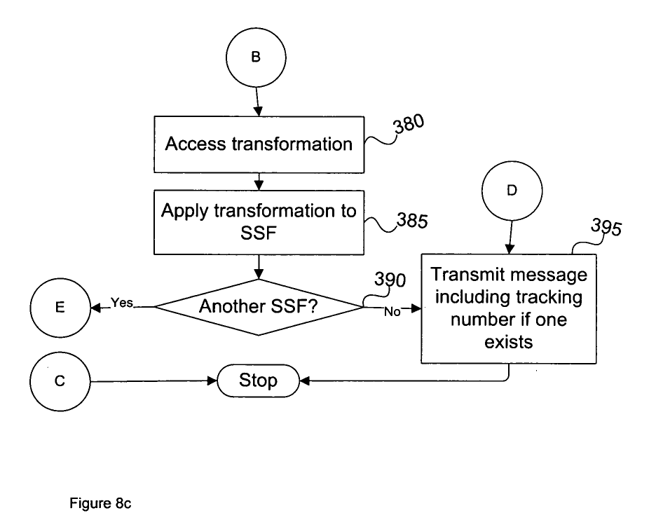

A modified SSG is illustrated in FIG. 7. The processing performed by an SSG, in accordance with one embodiment, is illustrated in FIGS. 8a, 8b and 8c. The figures should be read in conjunction with one another.

A message is received at step 300 by receiver component 50. This is a request message. (A reply message is later received by an SSG at step 300.) Firstly SSG tracking component 87 checks whether a tracking number is assigned to the message (step 305); in other words, whether the message is somehow associated with a previous message (e.g. a reply). (Inclusion of a tracking number is not necessarily definitive.) If the answer is yes, then processing proceeds to FIG. 8b. This will be discussed later.

If no tracking number has been assigned to the message, this may be a request (for which a reply will be received at a later date). As before, the message type is identified at step 310 by identifier 60 and appropriate message schema is accessed at step 320 by selector 70. At step 330, determiner 65 determines whether the message includes any SSFs. If the answer is no then the message is transmitted at step 395 by transmitter 95 and processing ends.

If the answer is yes, it is determined by tracking component 87 whether a tracking number has been assigned (step 340). For the first field, the answer will be no. Thus a tracking number is assigned and the SSF information is stored by the tracking component 87 in tracking information database 97 against the assigned tracking number (step 360). (It should be appreciated that multiple SSFs in a message will preferably have one tracking number assigned to cover all the SSFs for that message.) Processing then proceeds to FIG. 8c.

Processing then continues as for the first embodiment. An appropriate transformation is accessed at step 380 by the transforming component 80 and is applied to the SSF at step 385. The newly applied transformation may also be stored against the assigned tracking number.

It is then determined by determiner 65 whether there is another SSF (step 390). If the answer is no, then the message is transmitted by transmitter 95 and processing ends.

If the answer is yes, then processing continues with step 360 and the tracking component 87 stores the SSF information against the assigned tracking number. Processing then continues with FIG. 8c where the appropriate transformation is accessed and applied at steps 380, 385.

Processing continues until there are no more SSFs (step 390) and the message is transmitted at step 395 including the assigned tracking number. Processing then ends.

The transmitted message is then received by an SSG at step 300 of FIG. 8a. This message does include a tracking number (step 305) and so processing proceeds to FIG. 8b. The SSG tracking component 87 retrieves any information it has stored in its tracking information database 97 which is associated with the tracking number of the received message (step 375). The tracking component then may reverse the originally applied transformation with the retrieved information in order to enrich the message content (step 375). The transmitter 95 then transmits the message at step 377 and processing ends.

Note, the tracking number may have associated with it the original contents of the SSF and in addition a transformation that was applied before the request message was sent on. The additional information with respect to the applied transformation can be used to see whether the transformation detail has been modified by the replying entity. If what was sent out in the request is the same as what is received in the reply, then it may be valid to simply use the original information (before a transformation was applied to the request)—i.e. to reverse the originally applied transformation.

In the disclosed embodiment, a tracking number is assigned to the message itself. In an alternative embodiment, a different identifier is assigned to each SSF.

Note, it should be possible to tell from the characteristics of the message (e.g. source and destination) whether it is appropriate to store tracking numbers etc. Some destinations will always be services which will require a request/reply interaction. In other instances, it is possible to configure the SSG appropriately (i.e. this will be a configuration option for certain types of messages.)

It is possible to tell if a message is a request of a reply by the direction of the message. If it is outbound, then it is a request and if it's inbound then it is either a reply, or an unsolicited request from the other end. As indicated previously, the inclusion of a tracking number in a received message does not definitively indicate that the message is a reply.

To summarise, the solution disclosed preferably has two parts to it:

(i) The ability to mark a field in the event schema as a “scope sensitive field”; and

(ii) A component called a scope sensitive event gateway. This sits inside the event processing network at places where a change of scope occurs (for example, where the event is passing from a local system to the corporate network, or is passing between organizations). Its job is to update the SSFs so they contain values that are appropriate for the current scope that the event is travelling through. For example, in a factory, an event could be created that records a package entering the warehouse. The event could describe the location of the package in terms of shelf that it is sitting on. This is sufficient information for all of the systems within the warehouse. However, this event may be passed to the corporate systems such as stock control, and order processing. As the event leaves the warehouse systems, the scope sensitive event gateway will change the location of the package to include the building number and address so that the package can be located from a more global context. If the event was later passed onto a external distributor, another gateway may strip out the shelf details since they are private to the factory (and likely to be wrong by the time the lorry turns up to collect the package).

It should be appreciated that the SSG may delete, replace or augment or reduce a scope sensitive field. It should further be appreciated that whilst the invention has been described in terms of SSFs relating to time or location, no limitation in this regard is intended.

It should further be appreciated that the present invention is not intended to be limited to event processing. This is used for exemplary purposes only. Rather the invention relates to message passing in general.

1. A method for modifying a message, the method comprising:
receiving a message from a first entity, the message containing a first level of detail appropriate to the first entity, the message for communication to a second entity;
determining whether the message contains a scope sensitive field;
responsive to determining that the message does contain a scope sensitive field, accessing information indicating how to transform the scope sensitive field to a second level of detail appropriate to the second entity; and
transforming the scope sensitive field to produce the second level of detail.

2. The method of claim 1, wherein the step of determining whether the message contains a scope sensitive field comprises:
identifying a message type; and
accessing a message schema for the identified message type, the message schema indicating whether the message contains any scope sensitive fields.

3. The method of claim 1 further comprising:
transmitting the message including the transformed scope sensitive field to the second entity.

4. The method of claim 1, wherein the step of transforming the scope sensitive field comprises one of: deleting; modifying; or replacing the scope sensitive field.

5. The method of claim 1 further comprising:
determining whether the message includes a tracking number; and
responsive to determining that the message does include a tracking number, using that tracking number to transform an associated scope sensitive field.

6. The method of claim 5, wherein the step of using the tracking number to transform an associated scope sensitive field comprises:
retrieving scope sensitive field information associated with the tracking number.

7. The method of claim 5 further comprising:
responsive to identifying a field as scope sensitive and responsive to determining that that the message does not include a tracking number, assigning the message a tracking number and associating the scope sensitive field's information with the tracking number.

8. The method of claim 5 further comprising:
transmitting the message including the assigned tracking number.

9. An apparatus for modifying a message, the apparatus comprising:
means for receiving a message from a first entity, the message containing a first level of detail appropriate to the first entity, the message for communication to a second entity;
means for determining whether the message contains a scope sensitive field;
means, responsive to determining that the message does contain a scope sensitive field, for accessing information indicating how to transform the scope sensitive field to a second level of detail appropriate to the second entity; and
means for transforming the scope sensitive field to produce the second level of detail.

10. The apparatus of claim 9, wherein the means for determining whether the message contains a scope sensitive field comprises:
means for identifying a message type; and
means for accessing a message schema for the identified message type, the message schema indicating whether the message contains any scope sensitive fields.

11. The apparatus of claim 9 further comprising:
means for transmitting the message including the transformed scope sensitive field to the second entity.

12. The apparatus of claim 9, wherein the means for transforming the scope sensitive field is operable to perform on e of the following: deleting; modifying; or replacing the scope sensitive field.

13. The apparatus of claim 9 further comprising:
means for determining whether the message includes a tracking number; and
means, responsive to determining that the message does include a tracking number, for using that tracking number to transform an associated scope sensitive field.

14. The apparatus of claim 13, wherein the means for using the tracking number to transform an associated scope sensitive field comprises:
means for retrieving scope sensitive field information associated with the tracking number.

15. The apparatus of claim 13 further comprising:
means, responsive to identifying a field as scope sensitive and responsive to determining that that the message does not include a tracking number, for assigning the message a tracking number and associating the scope sensitive field's information with the tracking number.

16. The apparatus of claim 13 further comprising:
means for transmitting the message including the assigned tracking number.

17. A computer program comprising program code means operable to perform a method for modifying a message when said program is run on a computer, the method comprising:
receiving a message from a first entity, the message containing a first level of detail appropriate to the first entity, the message for communication to a second entity;
determining whether the message contains a scope sensitive field;
responsive to determining that the message does contain a scope sensitive field, accessing information indicating how to transform the scope sensitive field to a second level of detail appropriate to the second entity; and
transforming the scope sensitive field to produce the second level of detail.
